(19) United States
(12) Patent Application Publication
(10) Pub. No.: US 2008/0245612 A1
(43) Pub. Date: Oct. 9, 2008

(54) Moldular, External Emergency Structure Particularly Suitable for use as a Fire Escape

(76) Inventor: Salvatore Catania, S. Giovanni La Punta (IT)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 10/595,178

(22) PCT Filed: Oct. 2, 2003
(86) PCT No.: PCT/IB2003/004358

§ 371 Date: Mar. 17, 2006

(51) Int. Cl. A62B 1/20

(52) U.S. Cl. 182/48

(57) ABSTRACT

This invention relates to a modular, external emergency structure particularly suitable for use as a fire escape. This structure comprises several modules stacked one on top of the other; the modules have a closed top surface featuring means suitable to open under the weight of a person and close immediately afterwards. In this way, said person falls into each module in succession in a controlled way, slowing down the fall. The structure comprises a bottom module found at ground level and several other modules, preferably different from the bottom module, to be stacked on top of the bottom module. Ideally, the height of each module should not be less than the height of the floor of the building to which it is connected; while, the height of the structure should not be less than the height of the last floor of the building to which said structure is connected.

### TECHNICAL FIELD

This invention relates to a modular, external emergency structure. More particularly, it relates to a structure, particularly suitable for use as a fire escape, comprising several modules stacked one on top of the other that have a closed top surface provided with means suitable to open under the weight of a person and close immediately afterwards. In this way, said person falls into each module in succession in a controlled way, slowing down the fall.

### BACKGROUND ART

The prevention and safety standards currently in force for public buildings, especially those on fire safety, require building of emergency structures suitable for the fast and, as much as possible, safe evacuation of the building during an emergency such as a fire.

The most widespread kind of emergency structure consists of several flights of stairs, placed inside or outside the building, that connect one or more floors of the building to the ground level and, possibly, to each other.

In normal conditions, the flights of stairs can be used as, an alternative, way in or out of the building and/or to connect the different floors to each other; however, in an emergency, stairs can present the serious drawbacks common to all escape ways destined to be used by throngs of often panic-stricken people. For example, if someone falls on the stairs, not at all an infrequent and/or unlikely event, this may be enough to block, at least partially, the escape way, causing serious injury or even loss of life at least to the people involved in the fall.

The emergency structure in accordance with this invention does not suffer from the above serious drawbacks since the people evacuate the building by falling down a “tower” in a controlled manner. Said “tower” is constructed externally and is appropriately connected to the building with emergency exits accessible from one or more floors of the building.

### OBJECTS OF THE INVENTION

It is the object of this invention to provide a modular, external emergency structure, particularly suitable for use as a fire escape, comprising several modules stacked one on top of the other that have a closed top surface provided with means suitable to open under the weight of a person and close immediately afterwards. In this way, said person falls into each module in succession in a controlled way, slowing down the fall.

Ideally, the height of each module should not be less than the height of the floor of the building to which it is connected; while, the height of the structure should not be less than the height of the last floor of the building to which said structure is connected.

### DRAWINGS

Other advantages of the invention shall be apparent from the more detailed description of particular versions of the invention, given as nonlimiting examples and in conjunction with the following accompanying drawings:

FIG. 1 shows a perspective view of a part of the structure comprising several modules;

FIG. 2 shows a sectional view of a structure suitable for evacuating one floor of the building and comprising a ground-level module and several modules of the type displayed in FIG. 1;

FIG. 3 shows a sectional view of a structure that differs from the one displayed in FIG. 2 in the ground-level module;

FIG. 4 shows a schematic top view of the upper surface of the modules of the type shown in FIG. 1;

FIG. 5 shows a schematic top view of the upper surface of the ground-level module;

FIG. 6 shows a perspective view of a first version of two stacked modules;

FIG. 7 shows a perspective view of a second version of two stacked modules;

In the attached Figures, the corresponding items shall be identified with the same reference numbers.

### DESCRIPTION OF THE INVENTION

The external emergency structure in accordance with this invention is of the modular kind and comprises several modules stacked one on top of the other. Each module comprises a closed top surface featuring means suitable to open under the weight of a person and close immediately afterwards. In this way, said person falls into each module in succession in a controlled way, slowing down the fall.

Ideally, the height of each module should not be less than the height of the floor of the building to which it is connected, often, the height of the ground floor is different than the one of the other floors; while, the height of the structure should not be less than the height of the last floor of the building to which said structure is connected.

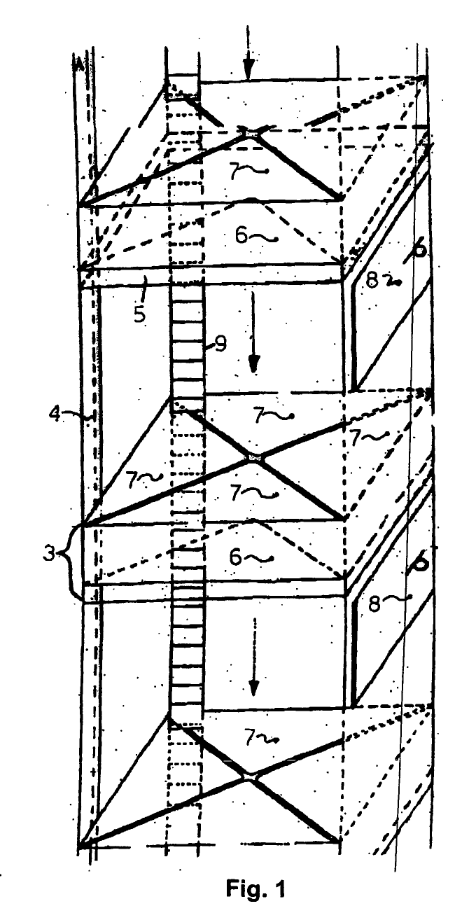

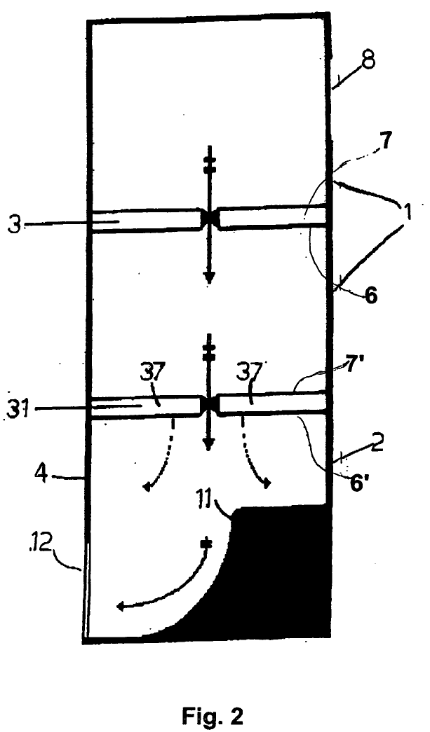

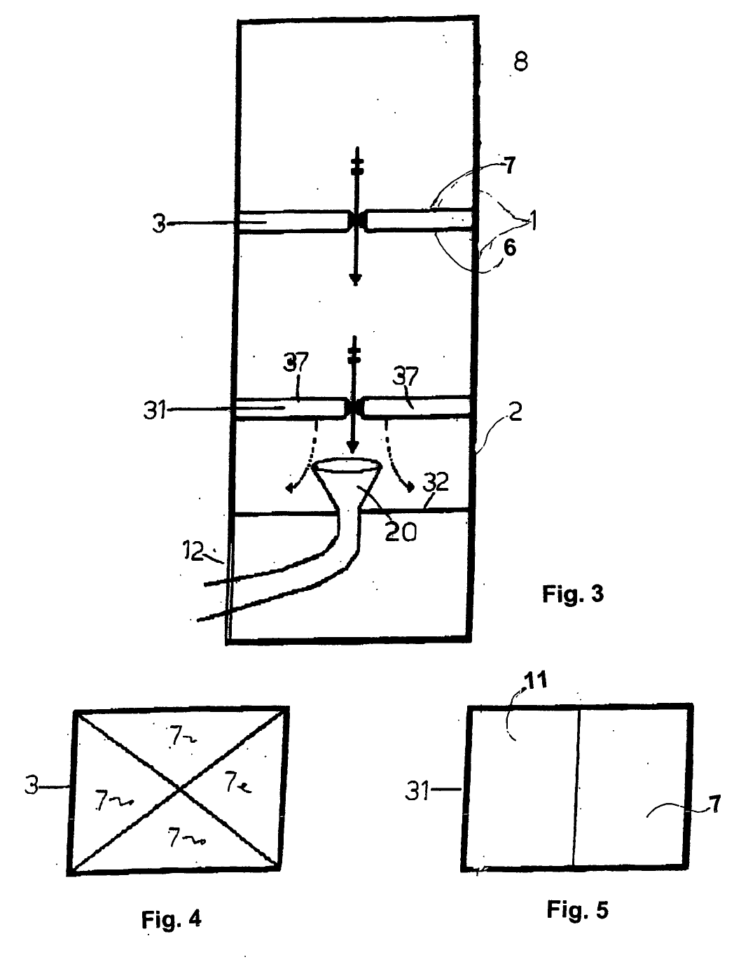

The external emergency structure in accordance with this invention comprises a bottom module 2—FIGS. 2, 3, placed at ground level and several other modules 1—FIG. 1, stacked on top of the bottom module 2.

Each module 1, 2 comprises a frame consisting of, in the version described herein, uprights 4 joined together with cross members 5. Furthermore, to prevent the person from bouncing out of the module during the fall, suitable enclosing means, for example, panels made of fireproof material, are, preferably, fastened to the frame, forming the walls of the module. The latter have been omitted from the attached drawings for the sake of clarity and simplicity.

In addition, each module 1, 2 comprises means, which have been omitted from the attached drawings for the sake of clarity and simplicity, for connecting it at least to an adjacent module 1, 2 and for attaching it to the outer wall of the building.

Said connecting and attaching means are of the known kind and, consequently, shall not be described herein.

Ideally, the modules 1, 2 have a square section with a side length of approximately 2,5 metres; anyhow, this side length is included between 1,8 and 4 metres, approximately. The section of the modules may not be rectangular. The minimum size of the section length is equal to 1,60 metres.

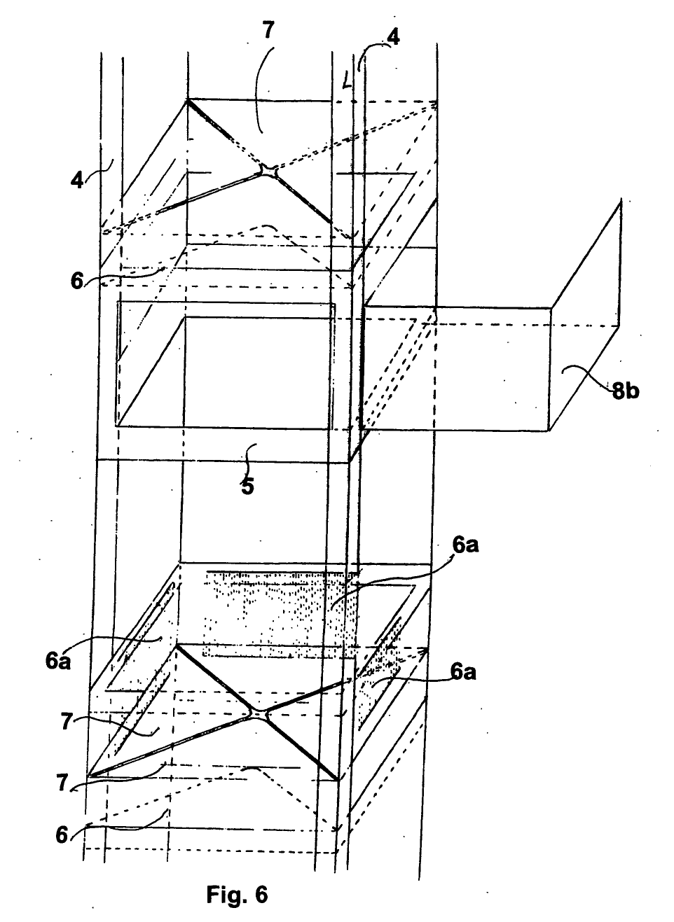

The top surface 3, 31 of each module 1, 2 is attached to at least one of the cross members 5 and comprises supporting means 6 with cushioning devices 7. Said supporting means 6 are flexible, are attached to at least one cross member 5 at one end, and, advantageously, are attached to the walls of the module 1, 2 through elastic means 6a—FIG. 6. Said elastic means, under strain, allow the supporting means 6 to open gradually under the weight of the person, enabling the person to enter the module in a controlled way, and to close after the passage of the person, effectively breaking the fall.

The flexibility—which increases from the base to the free end—of the supporting means 6, combined with the elasticity of the elastic means, creates a structure that features a resistance that is proportional to the distance from the walls of the point of impact of the person and to said person's weight.

While remaining within the scope of the invention, the elastic means 6a may consist of springs and/or shock absorbers, preferably, but not necessarily, with differential resistance, and/or other functionally equivalent means that are of the known kind and, consequently, shall not be described herein.

The cushioning devices 7 are integral with the supporting means 6 and are able to absorb or, at least, to dampen, the kinetic energy of a person in free fall in the module 1 above, slowing down the fall. Examples of said cushioning devices include cushions, made of rubber, foam rubber, et cetera, and/or air mattresses similar to the ones used by fire brigades and/or other functionally equivalent means that are of the known kind and, consequently, shall not be described herein.

The supporting means 6 and the cushioning devices 7 will not be further described herein because their realization and the sizing of the flexible supporting means 6 and the relating elastic means 6a can be carried out by an expert technician without the need for additional inventions.

In the attached Figures, arrows indicate the direction in which the persons move inside the structure.

FIG. 1 shows a perspective view of a part of a structure in accordance with the invention. Said structure comprises several modules 1; each module includes at least a frame consisting of uprights 4 joined together with cross members 5 and a top surface 3 consisting of supporting means 6—attached to a cross member 5 at one end—and cushioning devices 7, carried by the supporting means 6.

FIG. 1 does not show the bottom module 2—FIGS. 2, 3, which should be placed at ground level and serves as base for piling up the modules 1.

Preferably, the top surface 3 of a module 1 consists of supporting means 6 and cushioning devices 7 of triangular shape FIG. 4; however, while remaining within the scope of the invention, the top surface 3 of a module 1 may differ from the one given as example in FIGS. 1 and 4. The top surface 31 of the bottom module 2—FIGS. 2, 3, and 5 consists of two parts: rectangular supporting means 6′ that carry two rectangular cushioning devices 7′. This form of realization can also be used for the top surface of the other modules 1.

In addition, in FIG. 1, each module 1 comprises a door 8 having a shape and size suitable to allow persons to access the structure easily: this access door 8 is housed in the wall of the module 1 facing the building, is normally positioned aligned with an emergency exit 8b of the building, and is, preferably, a fire door.

The doors 8 shown in FIG. 1 are of the “drawbridge” kind; however, while remaining within the scope of the invention, the doors 8 may be shaped and/or sized each time to meet the specific needs of each structure.

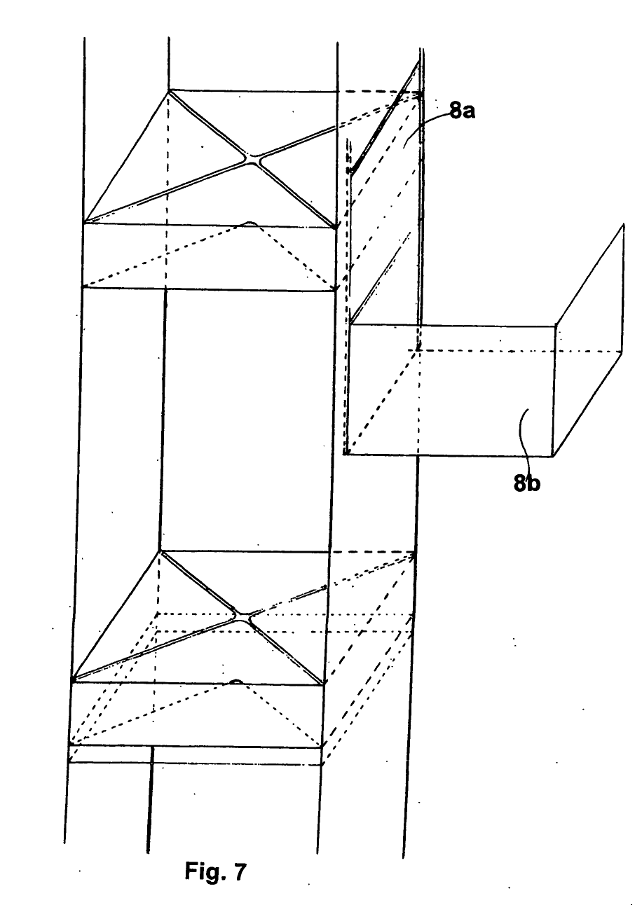

Another version of the invention, shown in FIG. 7, comprises vertically sliding doors 8a; an automatic device controls door opening and closing and is used to control user entry into the module.

Finally, in the example shown in FIG. 1, each module 1 comes with backstairs and/or emergency stairs 9, which can be omitted while remaining within the scope of the invention.

The structure shown in FIG. 1, together with a bottom module 2 shown in FIGS. 2, 3 is suitable for connecting at least two floors of the building to the ground level—each floor being connected to a module 1 featuring an access door 8. To prevent any overcrowding of the structure due to the, almost, simultaneous entry of several persons into the same module 1, 2, it is necessary, or, at least, highly advisable, for the access doors 8 and/or the top surface 3, 31 of each module 1, 2 to comprise locking means, which are of the known kind and, consequently, shall not be described herein. These locking means should prevent a person from accessing the module 1, 2 below if this module is occupied or if the access door 8 of said module is open or from opening the access door 8 of a module 1 if said module 1 is occupied and/or if the top surface 3 of said module 1 is opening.

While remaining within the scope of the invention, it is possible to construct an emergency structure comprising as many “towers” as number of floors of the building to be served. In this case, the height of each “tower” is essentially equal to the distance from the ground of the ceiling of the floor to be served and only the module 1 connected to said floor is equipped with an access door 8, which is housed in the wall facing the building and positioned aligned with an emergency exit on said floor, FIGS. 2, 3. Alternatively, it is possible to use several modules 1 of the type shown in FIG. 1; in this case, the doors 8 of the modules 1 below must be locked or, anyhow, must not be accessible.

This solution is more costly than the previously described one, but has the advantage of avoiding possible overcrowding problems of the “tower” and can be limited to the floors that have, or that are likely to have, a high number of people to be evacuated. Less-frequented floors of the building, for example, floors used for warehousing and/or filing, may be connected to one or more structures of the type described in FIG. 1.

FIG. 2 shows a sectional view of a structure suitable for evacuating one floor of the building, the second floor, in the version shown in FIG. 2. This structure comprises a bottom module 2 placed at ground level and several additional modules 1—two in the version shown in FIG. 2.

The bottom module 2 comprises a frame consisting of uprights 4 joined together with cross members 5, these have been omitted from FIG. 2 for the sake of clarity and simplicity and a top surface 31 that differs from the top surface 3 of the other modules 1—FIG. 1 essentially in that it comprises two bascule parts 37 consisting of supporting means 6′—attached to the cross members 5—and cushioning devices 7′—carried by the supporting means 6′—in the shape of a rectangle.

While remaining within the scope of the invention, the top surface 31 of the bottom module 2 can be the same as the top surface 3 of the other modules 1.

Furthermore, the bottom module 2 comprises a slide 11—which is of the known kind and, consequently, shall not be described herein—suitable for “accompanying” the persons coming from the module 1 above to the exit 12.

The bottom module 2 will not be further described herein because its construction, including the choice of materials for the slide 11 and the size of the module 2 and its top surface 31 to prevent any interferences between the person on the slide 11 and the top surface 31 of the module 2, can be carried out by a skilled person without the need for additional inventions.

In the structure given as an example in FIG. 2, the top module 1 has an access door 8 and its top surface cannot be opened, for example, because the supporting means 6 were preventively locked, the second module 1 does not have an access door 8 and its top surface 3 can be opened, while the bottom module 2 has an openable top surface 31.

FIG. 3 shows a sectional view of a structure in accordance with the invention that differs from the one displayed in FIG. 2 essentially in that the slide 11 of the bottom module 2 is replaced with at least a flexible cylindrical tube 20. This tube, which is supported by a support 32 and has a funnel-shaped opening, places the persons to be evacuated directly at the exit 12 of the bottom module 2.

While remaining within the scope of the invention, it is possible to replace the support 32 shown in FIG. 3 with a roundabout system, which is of the known kind and, consequently, shall not be described herein, that supports several flexible tubes 20.

FIGS. 2 and 3 show the opening movement of the bascule parts 37 by means of arrows.

FIG. 4 shows a schematic top view of the upper surface 3 of a module 1: the triangular cushioning devices 7 are visible, while the supporting means 6—which are hidden by the cushioning devices 7—and any elastic means 6a are not visible. FIG. 5 shows a schematic top view of the upper surface 31 of the bottom module 2, consisting of the two equal bascule parts 37: the cushioning devices 7′—belonging to the rectangular bascule parts 37—are visible, while the supporting means 6′—which are hidden by the cushioning devices 7′—and any elastic means 6a are not visible.

All the elements of the structure in accordance with the invention are made of fireproof material to make the structure suitable for use during a fire.

While remaining within the scope of the invention, a technician may make any changes and perfecting operations, as deemed advisable from acquired experience and from technological evolutions, to the modular, external emergency structure in accordance with this invention.

1. External emergency structure of the modular kind comprising a plurality of modules (1, 2) stacked one on top of the other, each defining a top surface (3, 31), the top surface (3, 31) being closed by means (6, 7) suitable to open under the weight of a person in order to allow said person to access the module (1, 2), slowing down the fall, and close immediately afterwards.

2. A structure as claimed in claim 1 wherein the height of each module (1, 2) is not less than the height of the floor of the building to which it is connected.

3. A structure as claimed in claim 1 wherein the height of the structure is not less than the height of the last floor of the building to which said structure is connected.

4. A structure as claimed in claim 1 comprising a bottom module (2), placed at ground level, and several modules (1) stacked on top of the bottom module (2).

5. A structure as claimed in claim 4 wherein each module (1, 2) comprises a frame at least consisting of uprights (4) joined together with cross members (5).

6. A structure as claimed in claim 5 wherein enclosing means are attached to the frame.

7. A structure as claimed in claim 4 wherein each module (1, 2) also comprises means adapted to connect it to at least an adjacent module (1, 2) and means apt to attach it to the outer wall of the building.

8. A structure as claimed in claim 4 wherein the modules (1, 2) have a square section with a side length included between 1,8 and 4 metres, approximately.

9. A structure as claimed in claim 8 wherein the modules (1, 2) have a square section with a side length of approximately 2,5 metres.

10. A structure as claimed in claim 5 wherein the top surface (3, 31) of each module (1, 2) is attached to at least one of the cross members (5) and comprises the supporting means (6) that carry the cushioning devices (7).

11. A structure as claimed in claim 10 wherein the supporting means (6) are flexible and are attached to at least one cross member (5) at one end.

12. A structure as claimed in claim 10 wherein the supporting means (6) are connected to the walls of the module (1, 2) through elastic means suitable to allow the supporting means (6) to open gradually under the weight of a person and to close after the passage of said person.

13. A structure as claimed in claim 10 wherein the cushioning devices (7) are integral with the supporting means (6) and are able to absorb the kinetic energy of a person in free fall in the module (1) above, effectively slowing down the fall.

14. A structure as claimed in claim 10 wherein the top surface (3) of each additional module (1) consists of supporting means (6) and cushioning devices (7) with a triangular shape.

15. A structure as claimed in claim 10 wherein the top surface (3) of an additional bottom module (1) consists of supporting means (6) and cushioning devices (7) with a rectangular shape.

16. A structure as claimed in claim 4 wherein each additional module (1) also comprises an access door (8) housed in the wall of the additional module (1) that faces the building and is aligned with an emergency exit of the building.

17. A structure as claimed in claim 16 wherein the access door (8) is a fire door.

18. A structure as claimed in claim 4 wherein backstairs and/or emergency stairs (9) are included in each additional module (1).

19. A structure as claimed in claim 16 suitable to connect at least two floors of the building to the ground level, wherein each of said floors of the building is attached to an additional module (1) comprising an access door (8).

20. A structure as claimed in claim 19 wherein the access door (8) of each additional module (1) comprises locking means suitable to prevent opening if the additional module (1) is occupied and/or if its top surface (3) is opening.

21. A structure as claimed in claim 19 wherein the top surface (3, 31) of each module (1, 2) comprises locking means suitable to prevent access to the module (1, 2) below if said module (1, 2) is occupied or if the access door (8) of said module (1) is open.

22. A structure as claimed in claim 16 suitable to connect only a floor of the building to the ground wherein only the additional module (1) attached to said floor of the building comprises an access door (8) housed in the wall facing the building and positioned aligned with an emergency exit on said floor.

23. A structure as claimed in claim 16 suitable to connect only a floor of the building to the ground wherein only the access door (8) of the additional module (1) attached to said floor of the building can be opened.

24. A structure as claimed in claim 22 or 23 wherein the height of the structure is essentially equal to the distance from the ground of the ceiling of said floor.

25. A structure as claimed in claim 10 wherein the top surface (31) of the bottom module (2) comprises two bascule parts (37) consisting of supporting means (6) and cushioning devices (7) in the shape of a rectangle.

26. A structure as claimed in claim 5 wherein the bottom module (2) also comprises a slide (11) suitable for “accompanying” the persons coming from the additional module (1) above to an exit (12).

27. A structure as claimed in claim 5 wherein the bottom module (2) also comprises at least a flexible cylindrical tube (20), which is supported by a support (32) and comprises a funnel-shaped opening, suitable for “accompanying” the persons coming from the additional module (1) above to an exit (12).

28. A structure as claimed in claim 28 wherein the bottom module (2) also comprises a roundabout system with several flexible cylindrical tubes (20) that comprise a funnel-shaped opening and are suitable for “accompanying” the persons coming from the additional module (1) above to an exit (12).
